(19) United States
(12) Patent Application Publication
(10) Pub. No.: US 2004/0137964 A1
(43) Pub. Date: Jul. 15, 2004

(54) Wireless communication device and method for responding to solicitations

(76) Inventors: Steven Lynch, Boston, MA (US); Steven Douglas Brennan, Boston, MA (US); Steven Walker, Needham, MA (US)

Correspondence Address: ROPES & GRAY LLP, ONE INTERNATIONAL PLACE, BOSTON, MA, 02110-2624, US

(21) Appl. No.: 10/662,976

(22) Filed: Sep. 15, 2003

Related U.S. Application Data
(60) Provisional application No. 60/410,863, filed on Sep. 13, 2002.

(51) Int. Cl. H04M 1/00; H04B 1/38

(52) U.S. Cl. 455/575.1; 455/566; 455/558

(57) ABSTRACT

A system and method for increasing the likelihood of a successful customer response to a solicitation is disclosed. The solicitation is distributed to a customer in the form of a hardcopy, with an electronic reply card being enclosed with or attached to the hardcopy. A user activates the electronic reply card for communication via a wireless communication channel and selects a response mode of the electronic reply card for replying to the solicitation. The selected response mode is transmitted to a provider associated with the solicitation. The customer receives via the communication channel or via a separate communication path a response from the provider according to the selected response mode.

### CROSS-REFERENCE TO OTHER PATENT APPLICATIONS

This application claims the benefit of U.S. provisional Patent Application No. 60/410,863, filed Sep. 13, 2002, the content of which is incorporated herein by reference in its entirety.

### BACKGROUND OF THE INVENTION

The invention relates to an electronic communication device, and more particularly to a wireless device allowing a customer or user to spontaneously respond to a solicitation received from a company merchant or service provider.

Commercial transactions, and in particular purchases of goods and services, are increasingly driven by advertising, incentives and promotions. Advertising media are, for example, radio and TV commercials, newspaper ads/inserts, flyers handed out on streets, in stores, shopping malls or at special events, as well as direct mailings.

Advertising most frequently includes incentives and promotions, referred to hereinafter as solicitations. A customer or potential customer will in many situations not be able to respond directly and immediately to such solicitations, but rather will have to mail a response, type the information into a computer, PDA or mobile phone, or physically travel to the store. The term “solicitation” used herein is to be understood to include presenting to the customer or client a physical medium, typically referred to as “hardcopy.” A hardcopy may be in the form of paper and/or plastic (for example, in a credit card style with or without encoded information), or in the form of a medium that is compatible with electronic devices (for example, a CD or a PCMCIA card). The hardcopy may be in the form of a newspaper insert, may be mailed to a recipient, included with or attached to an item of merchandise, for example, a cereal box or a beverage container/case or handed out in private or public settings, such as shopping malls, spots events or other sponsored events. This distribution mode of the hardcopy will hereinafter be referred to as “mailing,” although other distribution channels aside from traditional mailing campaigns are envisioned. Such mailings may include, for example, rebate coupons redeemable at a local store or a discounted subscription for a magazine, for a cable TV or satellite TV installation, etc.

There is a possibility that even a seriously interested customer may lose or misplace a solicitation of interest, forget about it or change his/her mind over time. As a result, many solicitations mailed or handed to a potential customer end up as trash, although the potential customer may have initially been intrigued by the solicitation and intended to spontaneously respond to it. In addition, a potential customer may have liked to receive more information immediately or a short while after receiving the mailing.

Accordingly, there is a need to provide a potential customer with a tool to directly and immediately respond to a solicitation received as a mailing or handout. Such tool should enable the customer to reply directly, without having to make a time-consuming phone call, filling out and mailing a response card, or switching on a computer to connect to a website. Such a tool should be inexpensive, easy to use and have an almost omnipresent connectivity to the intended company or service provider.

### SUMMARY OF THE INVENTION

The invention is directed to a system and method for increasing the likelihood of a successful customer response to a solicitation, for example, by a merchant or service provider.

According to one aspect of the invention, a communication device is distributed to a user as part of a solicitation and includes an enclosure or support, a wireless transmitter disposed in or on the housing or support and capable of transmitting in response to the solicitation data via a wireless communication channel, and an activation button to activate the device in at least two response modes. The response modes are preprogrammed in the device.

According to another aspect of the invention, a device for electronically responding to a solicitation from a merchant or service provider includes an electronic circuit card physically distributed by the merchant or service provider to a user and adapted for exchanging information between the merchant or service provider and the user. The electronic circuit card includes a stored electronic identifier identifying the merchant or service provider, a stored response options for a user response to the solicitation, as well as means for communicating the stored response option to the user, and means for directing a user response to the merchant or service provider.

According to yet another aspect of the invention, a solicitation is physically distributed to a customer. The solicitation includes an enclosure or support, an electronic response card enclosed in the enclosure or attached to the support, wherein the electronic response card further includes a wireless transmitter capable of transmitting data via a wireless communication channel, and an activation button to activate the device with a customer-selectable operating mode preprogrammed in the device.

According to still another aspect of the invention, a method for eliciting an electronic response from a customer to a solicitation physically distributed to the customer in form of an electronic device includes the acts of activating the electronic device for communication via a wireless communication channel, selecting a response mode of the device, transmitting the response mode to a provider, and receiving via the communication channel or a separate communication path a response from the provider conforming to the selected response mode.

According to another aspect of the invention, a method for increasing the likelihood of a successful customer response to a solicitation includes the acts of distributing the solicitation to a customer in the form of a hardcopy, enclosing with or attaching to the hardcopy an electronic reply card, activating the electronic reply card for communication via a wireless communication channel, selecting a response mode of the electronic reply card; transmitting said response mode to a provider associated with the solicitation, and receiving via the communication channel or via a separate communication path a response from the provider, wherein the provider response conforms to the selected response mode.

Embodiments of the invention may include one or more of the following features. The electronic response card can include a data input and output devices, such as a touch keypad for entering data in response to prompts and/or conforming with an operating mode of the device, as well as a display, such as an LCD display for displaying data entered by a user and/or the prompts. The operating or response mode of the device can be preprogrammed for ease of use or may be user-selectable based on a dialog with the soliciting company or service provider. The display may display, for example, a telephone number, an email address of a user or customer and/or an activation, promotion or savings code. Initially, the device can be activated by, for example, removing an activation strip.

The electronic response card can further include a wireless receiver capable of receiving data via the wireless communication channel. Both the transmitter and the receiver may be capable of operating with different transmission protocols over a plurality of communication channels.

The electronic response card may be in the form of an electronic circuit card that is integrated in the device. Alternatively, the electronic circuit card may be at least partially located in a wireless communication device, such as a mobile or cellular telephone, a wireless handheld computer or PDA. For example, the electronic circuit card may be in the form of a PCMCIA card that can be plugged or inserted in a slot in the wireless communication device.

Further features and advantages of the present invention will be apparent from the following description of preferred embodiments.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 is a flowchart of an exemplary conventional response to a mail solicitation;

FIG. 2 is a schematic diagram of a conventional mobile communication network;

FIG. 3 is a flowchart of an exemplary process according to the invention for responding to a mail solicitation;

FIG. 4 shows an exemplary embodiment of a communication device according to the invention;

FIG. 4A shows the communication device of FIG. 4 attached to a support;

FIG. 5 shows the communication device of FIG. 4 with a message prompt after user-selected activation of the device;

FIG. 6 shows the communication device of FIG. 5 with a user-supplied reply;

FIG. 7 shows another exemplary embodiment of a communication device adapted for use with a mobile telephone; and

FIG. 8 shows another exemplary embodiment of a communication device adapted for use with a wireless PDA.

### DETAILED DESCRIPTION OF CERTAIN ILLUSTRATED EMBODIMENTS

The devices, systems and methods described herein are directed, inter alia, to a wireless communication device and to a method for using the device for responding to solicitations. In particular, the devices described herein can transmit to and receive from a wireless network messages, such as messages relating to solicitations and product promotions.

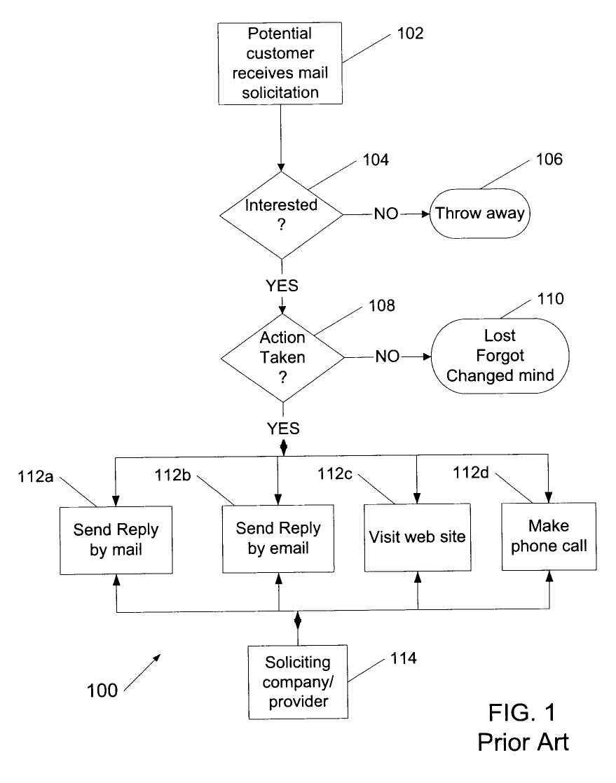

Referring first to FIG. 1, in a conventional process flow 100 for a traditional solicitation mailed by a company or service provider, a potential customer receives a mail solicitation, step 102. As mentioned above, the solicitation is typically in the form of a paper handout and requires are response from the potential customer. If the customer is not interested, possibly due to the perceived extra effort involved in providing a response, as determined in step 104, he/she will simply toss the solicitation away, step 106. If the customer is interested, he/she will still have to take action, step 108. However, the delay associated with responding to the solicitation and receiving a reply from the soliciting company or service provider may cause the customer to lose or misplace the solicitation, forget about it or to change his/her mind, step 110. If the customer decides to take action and respond, step 108, he/she can reply, for example, by regular mail (step 112a), by email (step 112b), visit the company's web site (step 112c), or make a phone call (step 112d). However, with all these response modes the rate of return will drastically decrease with the elapsed time after the potential customer received the solicitation.

One way of shortening the response time and facilitating an almost immediate response to a solicitation is to take advantage of the tremendous growth of wireless devices, such as mobile telephones, handheld computers, personal digital assistants (PDAs) and the like, which provide almost ubiquitous access to wireless services. More recently, data transfer over wireless telecommunication channels has become more widespread. Examples of wireless networks include pagers, Cellular Digital Packet Data (CDPD), Global System for Mobile Communications (GSM), Code Division Multiple Access (CDMA) and Time Division Multiple Access (TDMA) to name a few, and each of these wireless networks has different data transfer characteristics such as latency, bandwidth, protocols and connection methods. As examples, protocols can be Internet Protocol (IP), Short Messaging System (SMS) and Unstructured Supplementary Service Data (USSD), and connection methods can include packet switched or circuit switched. Data transfer does not tend to tax the network since most messages are short and can be conveniently transmitted during pauses in voice communication channels and even via the signaling channels.

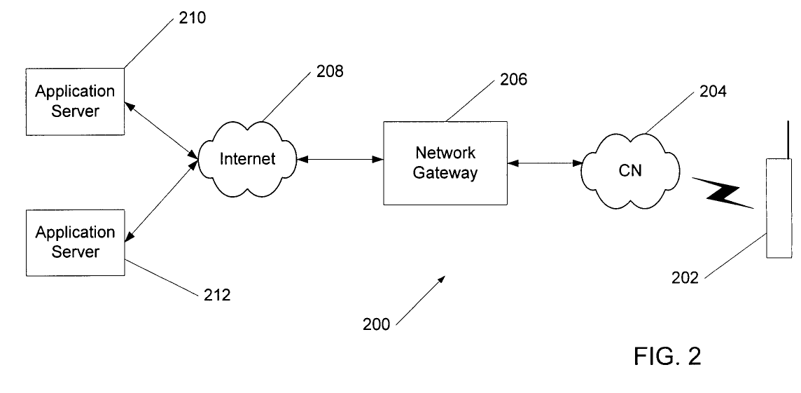

FIG. 2 is a schematic block diagram of a conventional communication system 200 suitable for coupling a mobile communication device to a wireless network. Specifically, the communication system 200 includes a mobile communication device 202, such as the device of the invention described in more detail below, that couples through a carrier network 204 to a network gateway 206. The network gateway 206 facilitates the coupling of the mobile communication device 202 with other networks, for example, the Internet 208. As is common, various computer systems, including computers supporting application servers 210 and 212 located at or connected to the soliciting company or service provider, can be coupled to the Internet 208. The primary function of the network gateway 206 is to receive data requests from the carrier network 204 and convert them into a suitable protocol, e.g., HTTP. Likewise, the network gateway 206 can also receive responses and converts them to data responses with a format (e.g., protocol) suitable for use with the carrier network 204 and the mobile communication device 202.

In conventional wireless networks, the mobile communication device 202 can be, for example, a pager, a mobile telephone, a wireless handheld PC or a PDA. Due to their small memory size, pagers were initially capable of only receiving messages from a base station. However, more recently, many paging receivers are actually paging transceivers which transmit acknowledgment signals back through the paging system. Due to the high power levels at which the base station transmits its paging signals, the signals are usually easily received by all paging transceivers located within the coverage area of the base station antenna.

Recently, dedicated paging systems have given way to more complex two-way communication devices, such as cellular phones with messaging capability, and wireless PDAs. Some of these devices have enhanced functionality, allowing them to send and receive extended messages, comprised of voice and/or data. Although the cost of such devices has decreased dramatically over the past few years, they typically still require an extended contract with a service provider and are outside the price range of being “throw-away” items.

Many geographic areas are serviced by more than one mobile carrier which may have agreements to service each other's customers without incurring additional charges, such as roaming charges. Switching from one carrier to another is then transparent to the consumer. A device that can work with multiple networks greatly enhances its capabilities and commercial appeal, since the availability of transmission devices operating on more than one transmission protocol, such as TDMA, CDMA, GPRS, GSM, 802.11, Bluetooth, as well as other emerging protocols, such as optical transmission, WINK, Wi-Fi, etc., almost guarantees ubiquitous access and communication, which is beneficial for the device disclosed herein, as will now be described.

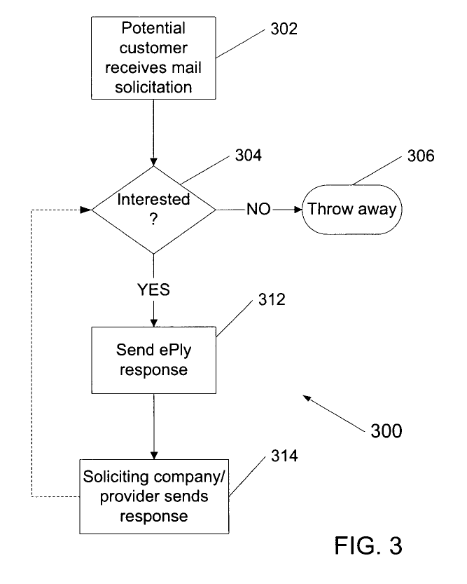

FIG. 3 depicts a process flow 300 according to the invention for responding to a solicitation mailed by a company or service provider. As will be appreciated from the following description of the process 300, the inventive process 300 provides for an immediacy in the response that is lacking in the traditional process 100 described above with reference to FIG. 1. In the process 300, a potential customer receives a mail solicitation, step 302, which requires are response from the potential customer. If the customer is not interested, as determined in step 304, he/she will simply throw the solicitation away, step 306. Conversely, if the customer is interested, he/she will have the opportunity to act immediately by sending an electronic response using an “Electronic Reply Card”, also referred to hereinafter as “ePly”-card, enclosed with the solicitation, step 312. The “ePly”-Card may already include, for example stored in a memory, an electronic identifier that identifies the soliciting company/provider to facilitate communication. The “ePly”-card may also include response option for a “pushbutton” response to the solicitation, as described below. The soliciting company/provider can respond immediately by sending information directly to the “ePly”-card, or to a device connected to the “ePly”-card, step 314. Several exemplary embodiments of the “ePly”-card will now be described.

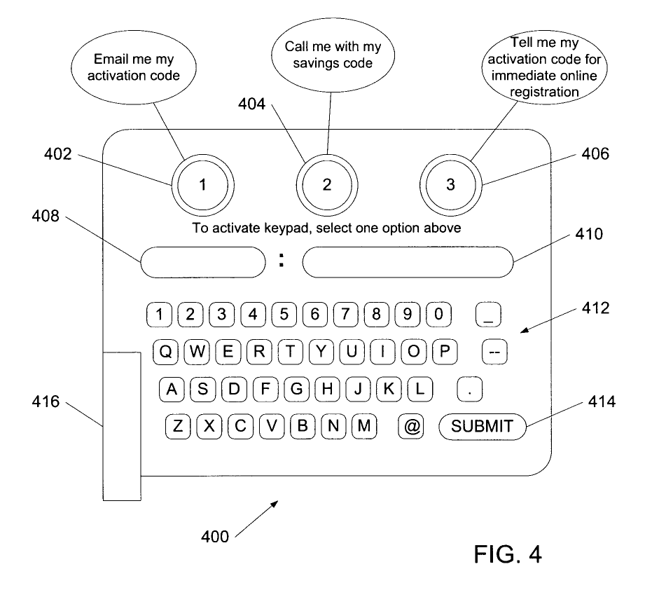

FIG. 4 depicts one exemplary embodiment of an Electronic Reply Card 400 that a potential customer may receive in a mailing or handout from a company or service provider, in the manner described above. This card can represent the mobile communication device 202 in FIG. 2 or another suitable electronic component, such a PCMCIA card, that can be inserted in or coupled to other electronic communication devices. Like a conventional pager or wireless PDA, the Electronic Reply Card can include a transmitter capable of transmitting messages which may have a reduced bit length compared to standard message traffic via PDAs and cellular phones. The Electronic Reply Card 400 can be adapted for communication with more than one mobile network, which can operate on different transmission standards and protocols, to allow ubiquitous communication capabilities.

In one practice, the Electronic Reply Card 400 can be adapted to transmit short messages. An exemplary short message protocol used in pagers is the POCSAG protocol originally authored by the British Post office code Standardization Advisory Group. Another paging protocol called ERMES was developed in Europe, utilizing many parts of the architecture of the POCSAG protocol in the adoption of the ERMES protocol. The POCSAG standard utilizes 2 code words, with the first code word of its frame containing the ID or address information for the pager. Code word two contains numeric or alphanumeric information. When the pager is in numeric mode, the code word can contain five numeric digits. Hence, the number of bits transmitted can be small.

In the exemplary embodiment depicted in FIGS. 4-6, the Electronic Reply Card 400 is shown as including a keypad 412, such as a touch keypad, allowing a user to compose messages, a display 408, 410, for example an LCD display, as well as activation buttons 402, 404, 406 and a submit button 414 which the user presses when sending a response to the soliciting company. The keyboard 412 may have a reduced character set and may be used primarily to enter the customer's name, telephone number and/or email address. A battery (not shown) that may have a short service life (allowing only a limited number of messages to be transmitted) may also be included to provide power to the transmitter/receiver.

As shown in FIG. 4A, the Electronic Reply Card 400 can be attached to a support 420, for example, made of plastic or sturdy paper or cardboard, that can be imprinted with promotional text or logos of a company or service provider and include operating instructions for responding to the solicitation. Alternatively or in addition, the Electronic Reply Card 400, with or without the support 420, can be placed in an enclosure, such as a mailing envelope or a package.

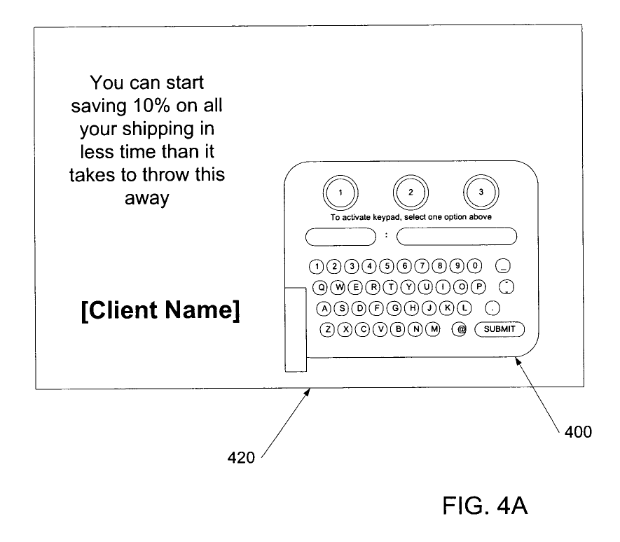

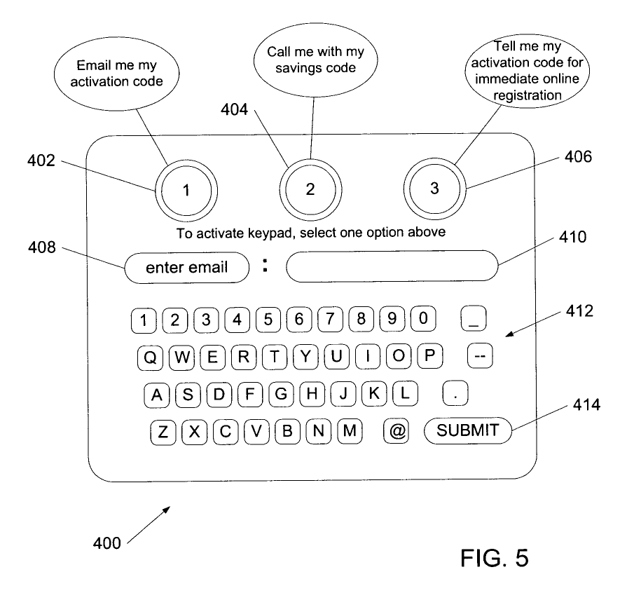

The user or potential customer may initiate and activate the Electronic Reply Card 400, for example, by removing an actication strip 416. As seen in FIG. 4, he/she will have several options to respond to the mailed solicitation. The Electronic Reply Card may be attached to a separate information sheet (not shown) which can include details of the solicitation and/or the company, and/or how to respond to the solicitation. The potential customer can then activate a communication mode/protocol with the mobile communication network by pressing at least one of the activation buttons 402, 404, 406 of the Electronic Reply Card 400 which can include preprogrammed responses for ease of operation. For example, the potential customer can press the button 402 “Email me my activation code” to request an activation code for activating, for example, an account or a service. For example, a customer may be enticed by a promotion for TV cable service to subscribe to the service. After the Electronic Reply Card 400 has been activated, the consumer may be prompted to enter data, such as his/her email address, as shown in the left display window 408 of FIG. 5. The consumer can then use the depicted keyboard 412 to enter his/her email address, as shown in the right display window 410 of FIG. 6, and press the “Submit” button to send this information, for example, to the soliciting service provider or a company via a wireless communication network. The service provider or company can then send the requested activation code related to the solicitation or promotion to the customer's email address. Any additional communication (email, voice) between the service provider and the customer could be conducted via traditional communication channels, such as email and telephone. The exemplary communication device 400 thus advantageously provides both the customer and the service provider/company with the tools to communicate spontaneously and instantaneously, thereby enhancing the business potential.

The second button 404 on the exemplary communication device 400 may state “Call me with my savings/activation code.” In this case, the consumer could be prompted on the left-hand display to enter his/her telephone number, which the customer would then enter in the same way as the email address, as described above.

Another option is depicted with reference to the third button 406 “Tell me my savings code now . . . ”, in which case the service provider or company would respond, preferably immediately, and send the activation code to the customer to be displayed, for example, in window 410. Whereas the first two examples require only a one-way communication from the customer to the service provider/company, this third example requires that the Electronic Reply Card has two-way communication capabilities.

It will be understood that the responses need not be preprogrammed and that a dialog between the service provider or company and the potential customer could be carried out by using the keypad 412 and the display 408, 410.

The exemplary Electronic Reply Card 400 may be designed for limited use, for example, one-time use. The keyboard can be simplified by having a telephone-style keypad, wherein alphanumeric characters can be entered with multiple keystrokes. This simplifies the design, and reduces cost.

Whereas the exemplary Electronic Reply Card 400 is shown as including the hardware for enabling wireless communication, such as at least a transmitter circuit and optionally also a receiver circuit, as well as data entry and display components, such features are already incorporated in modern consumer communication devices and systems, such as cellular telephones and wireless computers, such as handheld computers and PDAs. Accordingly, the input/output devices and the transceiver may be omitted from the electronic replay card by configuring the card to interface with existing wireless electronic devices. Modern cellular telephones and wireless computers increasingly include PCMCIA card slots to which PCMCIA cards can be connected. A PCMCIA card can include, for example, a camera, as disclosed in U.S. Pat. No. 6,427,078, additional memory and the like.

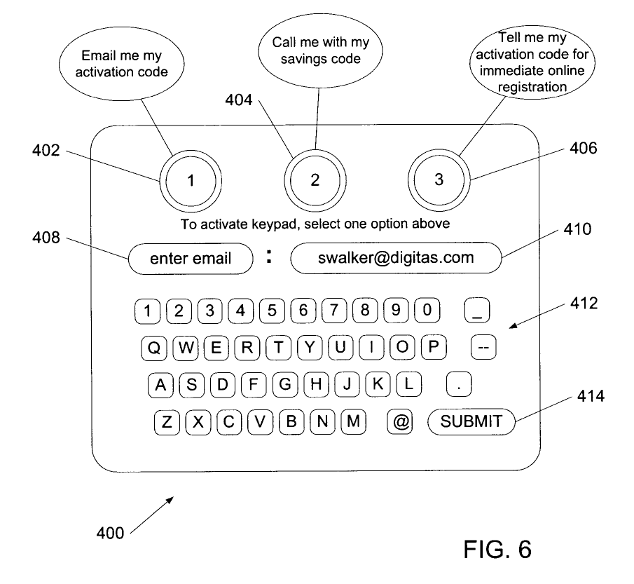

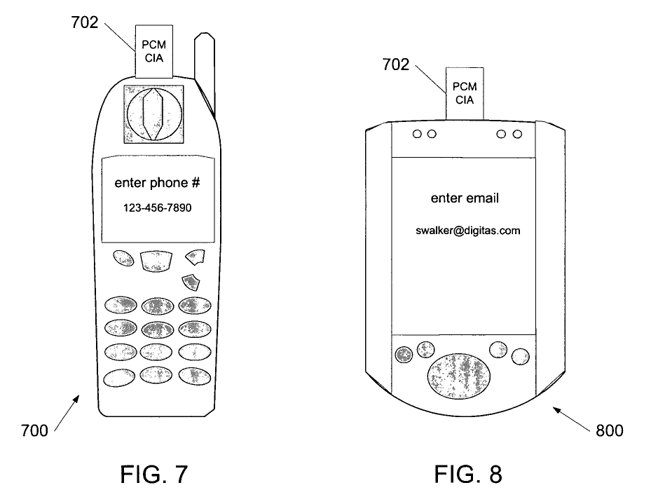

According to another embodiment of the invention shown in FIGS. 7 and 8, a PCMCIA card 702 adapted for connection to a cellular phone 700 (FIG. 7) or a PDA 800 (FIG. 8) can provide access to the wireless communication network 204 (FIG. 2) with the same functionality as the Electronic Reply Card 400 of FIGS. 4-6. The PCMCIA card 702 can include information about the soliciting company/service provider and prompts for responding to solicitations. The PCMCIA card 702 may be activated for its intended purpose simply by insertion into the device 700, 800 or by removing an activation strip (not shown) as described above with reference to the Electronic Reply Card 400.

While the invention has been disclosed in connection with the preferred embodiments shown and described in detail, various modifications and improvements thereon will become readily apparent to those skilled in the art. For example, the disclosed Electronic Reply Card can be used for general message exchange, subject to available message protocols, battery life, desired communication range, etc. The Electronic Reply Card can also operate without a built-in keyboard or keypad and without a display. For example, the Electronic Reply Card may begin sending a request for an activation or savings code when the cover strip is removed to initiate the card. Since the card could be part of a mailing campaign directed to a specific group of recipients, information about a recipient may also be pre-encoded in the card.

What is claimed is:

1. A communication device distributed to a user as part of a solicitation, the device comprising:
an enclosure or support,
a wireless transmitter disposed in or on the housing or support and capable of transmitting in response to the solicitation data via a wireless communication channel, and
an activation button to activate the device in at least two response modes, wherein the response modes are preprogrammed in the device.

2. The device of claim 1, further comprising a data input device for entering data corresponding to an response mode.

3. The device of claim 1, further comprising a display that displays a prompt to a user or data entered by the user in response to the prompt, or both.

4. The device of claim 2, further comprising a removable activation strip to activate the device.

5. The device of claim 1, further comprising a receiver adapted to receive data over the wireless communication channel.

6. The device of claim 1, further comprising a stored electronic identifier identifying a provider distributing the solicitation.

7. The device of claim 1, wherein the enclosure or support comprises an envelope, a package or a two-dimensional support structure.

8. A device for electronically responding to a solicitation from a merchant or service provider, said device including an electronic circuit card physically distributed by the merchant or service provider to a user and adapted for exchanging information between the merchant or service provider and the user, said electronic circuit card including:
a stored electronic identifier identifying the merchant or service provider;
a stored response options for a user response to the solicitation;
means for communicating the stored response option to the user; and
means for directing a user response to the merchant or service provider.

9. The device of claim 8, wherein the electronic circuit card further includes means for conveying a reply from the merchant or service provider to the user in response to the user response.

10. The device of claim 8, wherein the electronic circuit card is integrated in the wireless communication device, said wireless communication device further comprising a data input device and a display.

11. The device of claim 8, wherein at least a portion of the electronic circuit card is located inside the wireless communication device.

12. The device of claim 8, wherein the electronic circuit card is pluggable into the wireless communication device.

13. The device of claim 12, wherein the electronic circuit card comprises a PCMCIA card.

14. The device of claim 8 wherein the wireless communication device supports a plurality of communication channels capable of operating with different transmission protocols.

15. A solicitation physically distributed to a customer, comprising:
an enclosure or support,
an electronic response card enclosed in the enclosure or attached to the support, the electronic response card comprising:
a wireless transmitter capable of transmitting data via a wireless communication channel, and
an activation button to activate the device with a customer-selectable operating mode preprogrammed in the device.

16. The solicitation or promotion of claim 15, wherein the preprogrammed operating mode includes requesting an activation or savings code from a soliciting provider.

17. The solicitation or promotion of claim 15, wherein the enclosure or support comprises an envelope or package.

18. The solicitation or promotion of claim 15, wherein the enclosure or support includes a two-dimensional surface with imprinted information related to the solicitation.

19. The solicitation of claim 15, wherein the physical distribution includes mailing or handing out the enclosure or support to the customer.

20. Method for eliciting an electronic response from a customer to a solicitation physically distributed to the customer in form of an electronic device, comprising:
activating the electronic device for communication via a wireless communication channel;
selecting a response mode of the device;
transmitting said response mode to a provider; and
receiving via the communication channel or a separate communication path a response from the provider conforming to the selected response mode.

21. The method of claim 20, further comprising displaying the response from the provider and entering customer information in response to a displayed response.

22. The method of claim 20, further comprising transmitting via the wireless communication channel customer information to the provider conforming to the selected response mode.

23. The method of claim 22, wherein the customer information includes a telephone number or an email address of the customer.

24. The method of claim 21, wherein the displayed response includes at least one of a savings code and an activation code.

25. A method for increasing the likelihood of a successful customer response to a solicitation, comprising:
distributing the solicitation to a customer in the form of a hardcopy,
enclosing with or attaching to the hardcopy an electronic reply card,
activating the electronic reply card for communication via a wireless communication channel;
selecting a response mode of the electronic reply card;
transmitting said response mode to a provider associated with the solicitation; and
receiving via the communication channel or via a separate communication path a response from the provider, said provider response conforming to the selected response mode.

26. The method of claim 25, further comprising displaying the response from the provider and entering customer information in response to a displayed response.

27. The method of claim 25, further comprising transmitting via the wireless communication channel customer information to the provider conforming to the selected response mode.

28. The method of claim 27, wherein the customer information includes a telephone number or an email address of the customer.

29. The method of claim 26, wherein the displayed response includes at least one of a savings code and an activation code.
